(19) United States
(12) Patent Application Publication
(10) Pub. No.: US 2012/0255682 A1
(43) Pub. Date: Oct. 11, 2012

(54) TIRE SUPPORT STAND

(76) Inventor: Joseph C. Orr, Rexburg, ID (US)

(21) Appl. No.: 13/439,852

(22) Filed: Apr. 5, 2012

Related U.S. Application Data
(60) Provisional application No. 61/471,695, filed on Apr. 5, 2011.

(51) Int. Cl. F16M 11/04; B60B 30/00

(52) U.S. Cl. 157/14; 248/125.8

(57) ABSTRACT

A tire support stand includes a connecting arm and a telescopic arm, both connected to a securing bracket. The telescopic arm is pivotally connected to the securing bracket, while the connecting arm is firmly affixed to the securing bracket. The telescopic arm includes a sleeve member and an extendable arm which extends in and out of the sleeve member. The tire support stand has two configurations: (1) an upright configuration in which the connecting arm is mounted in a tripod; and (2) an L-shaped configuration in which the connecting arm is mounted to a trailer hitch receiver. In the upright configuration, a spindle platform is mounted on top of the connecting arm for receiving a tire. In the L-shaped configuration, the telescopic arm is rotated to a position perpendicular to the connecting arm and the spindle platform is mounted on top of the telescopic arm for receiving a tire.

### CROSS-REFERENCE TO RELATED APPLICATIONS

This application claims the benefit of priority from U.S. Provisional Patent Application Ser. No. 61/471,695 (filed Apr. 5, 2011). The entire content of Provisional Patent Application Ser. No. 61/471,695 is incorporated herein by reference in its entirety.

### STATEMENT REGARDING FEDERALLY SPONSORED RESEARCH OR DEVELOPMENT

Not Applicable.

### BACKGROUND OF THE INVENTION

Changing a tire on a vehicle such as, but not limited to, a motorcycle can be a laborious, time consuming process. This is why many people elect to have their tires changed at a professional mechanic's shop. However in many cases people may change the tire themselves, either voluntarily, or due to circumstances beyond their control. For those who choose to change their own tires it is convenient to set up a tire changing station in a garage or some other suitable location. However, if a motorcycle rider has a flat tire away from home, the tire must either be repaired and/or changed on the spot, or the bike must be transported back to a tire changing station. There is therefore a need for a portable tire changing station that can be safely set up away from home.

U.S. Pat. No. 1,206,802 which describes a foldable tire carrier that may be folded to occupy small space when not in use. The '802 tire carrier may be arranged to hold one tire, or it may be extended laterally to be adapted to hold two tires arranged side by side.

U.S. Pat. No. 4,976,449 describes a portable wheel dolly comprised of a shaft, a first support frame and a second support frame held in spaced, parallel relationship in an operating configuration and in end-to-end relationship in a stored configuration. The first and second support frames have inclined face plates to support one or more tires in an upright position. The shaft slides through slip sleeves at the midpoint of the first and second support frames and engages nut to hold the dolly in the operating configuration. The shaft slides through sleeves and engages a nut to hold the first and second support frames in the stored configuration.

U.S. Patent Publication Number 20090071915 describes a tire support stand to support an array of tires in substantially upright positions for convenient display or processing. The stand includes a T-shaped base. A post extends upwardly and angularly from the base. Tire tread-engaging members are disposed on the base. A tire-engaging member is disposed at the upper end of the post. Brace support members are attached to the base and post to ensure stability. A handle is provided on the post to enhance portability.

U.S. Pat. No. 6,863,488 describes a foldable dolly for moving and positioning a vehicle tire assembly is formed with a rectangular base member mounted on a plurality of casters. Two wings are hinged to opposite ends of the rectangular member and have adjustable positioning members having one end attached to the base member and the other end attached to one of the wings. A plurality of bearings at least one bearing being mounted on each wing and one on the rectangular base member allow rotation of the tire assembly on the dolly and easy withdrawal of the dolly when the tire is mounted on a vehicle.

U.S. Pat. No. 1,864,234 describes a stand for supporting a tire casing in upright display position. More specifically, the '234 tire stand works by cradling a tire casing between pivoted stand sections or jaws.

None of the above inventions and patents, taken either singly or in combination, is seen to describe the instant invention as claimed.

### SUMMARY OF THE INVENTION

A tire support stand includes a connecting arm and a telescopic, both of which are connected to a securing bracket. The connecting arm is firmly affixed to the securing bracket, while the telescopic arm is pivotally connected to the securing bracket. The telescopic arm includes a sleeve member and an extendable arm that extends in and out of the sleeve member.

The connecting arm may be attached to a trailer hitch receiver or a tripod. In the tripod or “upright” configuration, the connecting arm is in a vertical orientation with the telescopic arm folded to a position adjacent the connecting arm. In this position, the extendable arm is generally not extended from the sleeve member of the telescopic arm. The spindle platform is mounted at the top of the connecting arm for receiving a tire. A tire can be placed on top of the spindle platform for repair and/or changing.

In the trailer hitch or “L-shaped” configuration, the connecting arm is in a horizontal orientation, while the telescopic arm is rotated to an open vertical position, perpendicular to the connecting arm, thus forming an L-shape. A securing pin is used to tighten the telescopic arm in place and keep it from moving. The spindle platform is mounted at the top of the extendable arm for receiving a tire. In this configuration, the extendable arm is height adjustable to allow easy access to a tire.

### BRIEF DESCRIPTION OF THE DRAWINGS

FIG. 1 is a perspective view of a folded tire support stand disconnected from a tripod, according to the present invention.

FIG. 2 is a perspective view of an open tire support stand disconnected from the tripod.

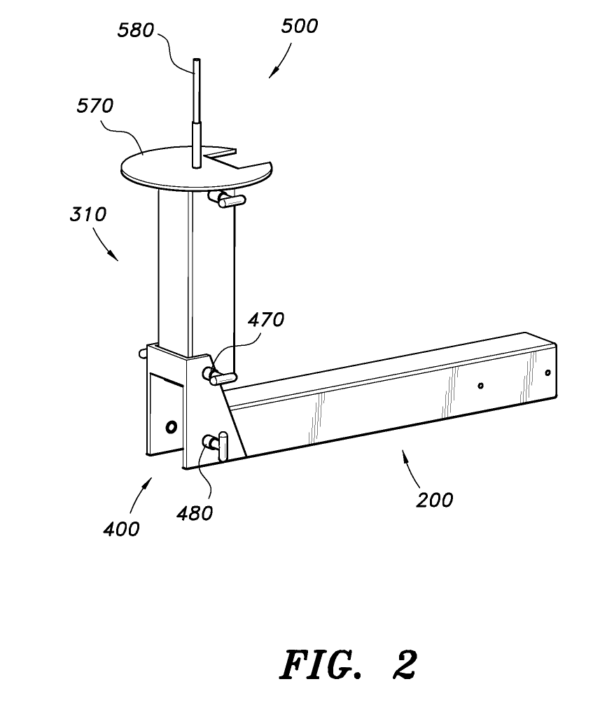

FIG. 3 is a perspective view of an open tire support stand disconnected from the tripod.

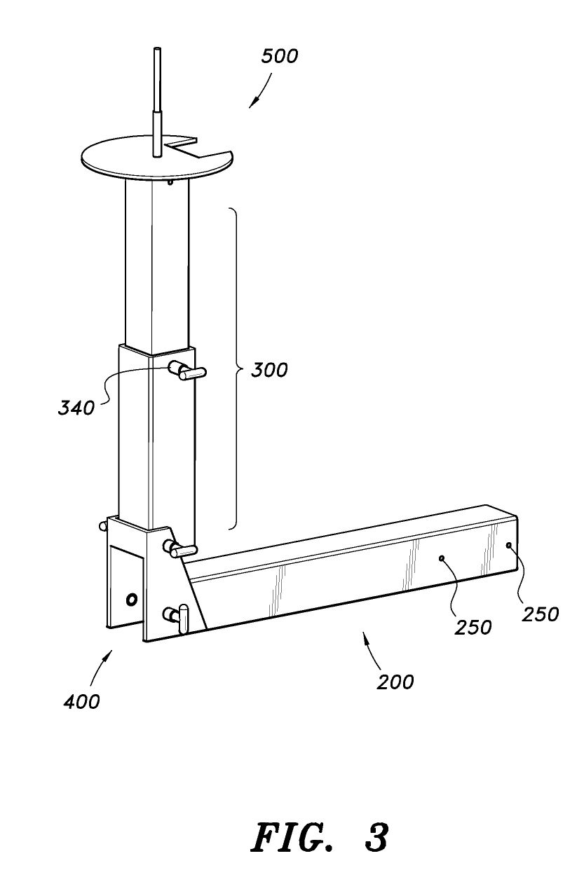

FIG. 4 is a perspective view of a folded tire support stand disconnected from the tripod.

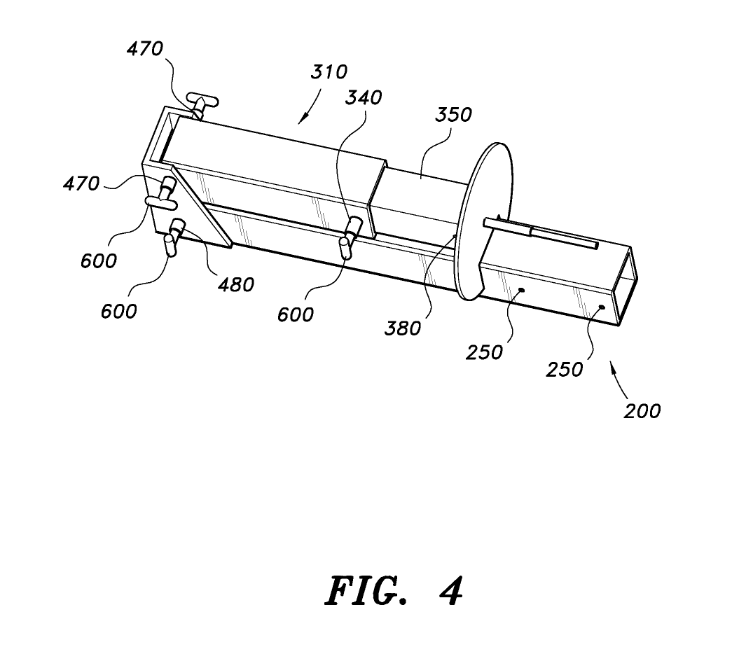

FIG. 5 is an environmental, perspective view of a tire support stand according to the present invention.

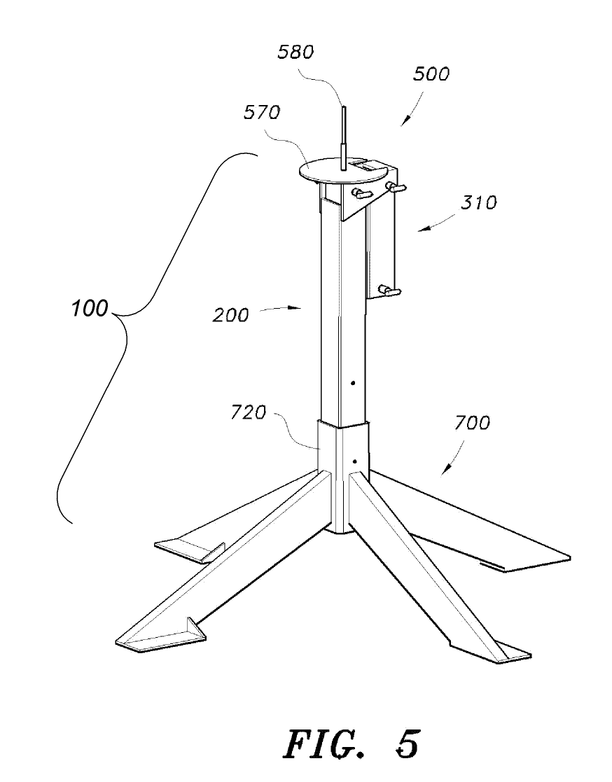

FIG. 6 is a perspective view of a folded tire support stand disconnected from the tripod.

FIG. 7 is an environmental, perspective view of a tire support stand according to the present invention.

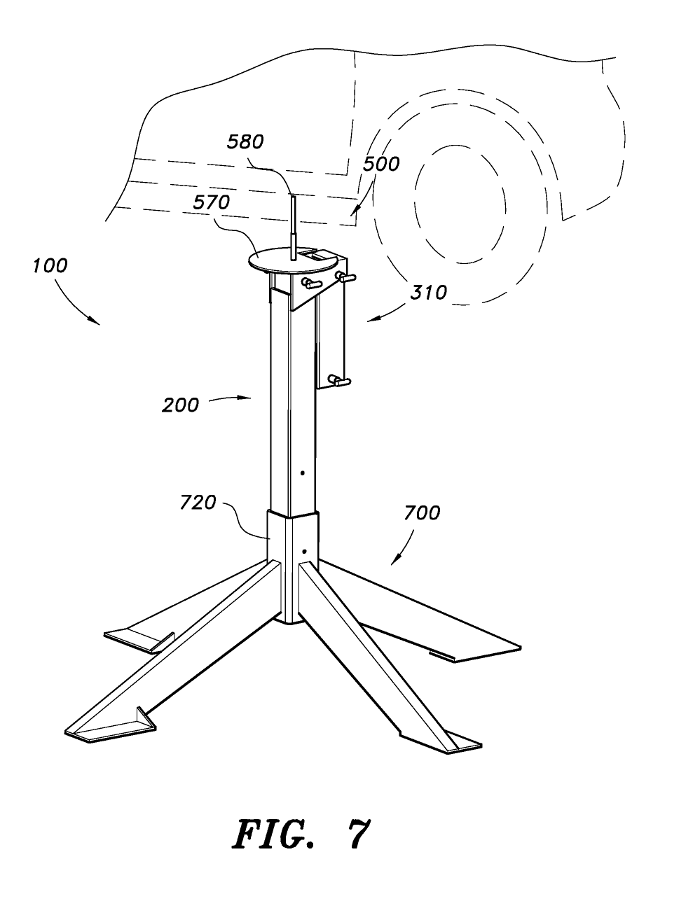

FIG. 8 is an environmental, perspective view of an open tire support stand disconnected from the tripod.

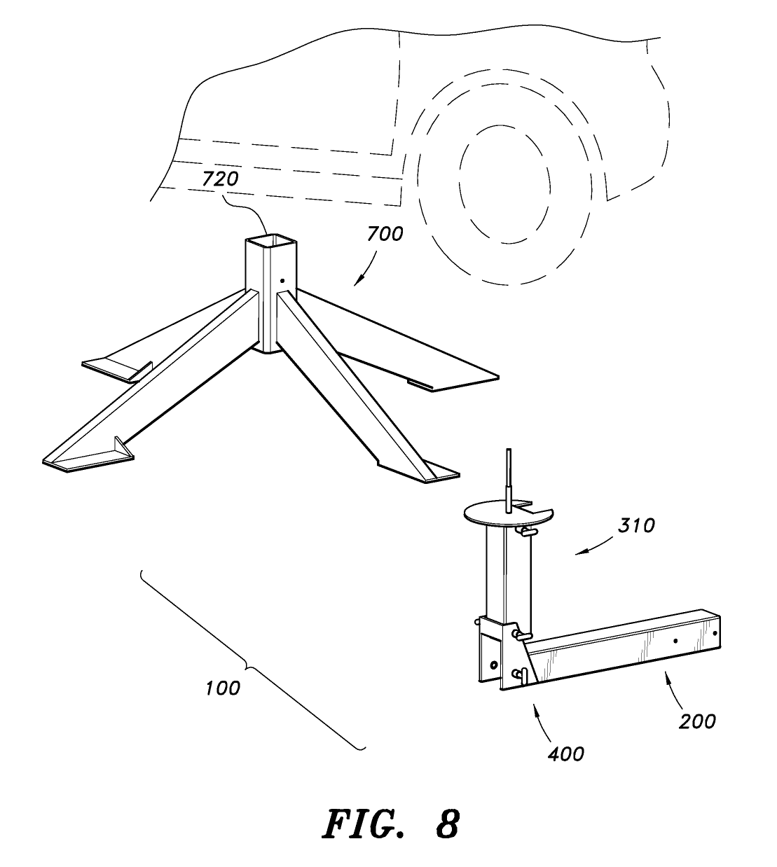

FIG. 9 is an environmental, perspective view of the tire support stand connected to a trailer hitch.

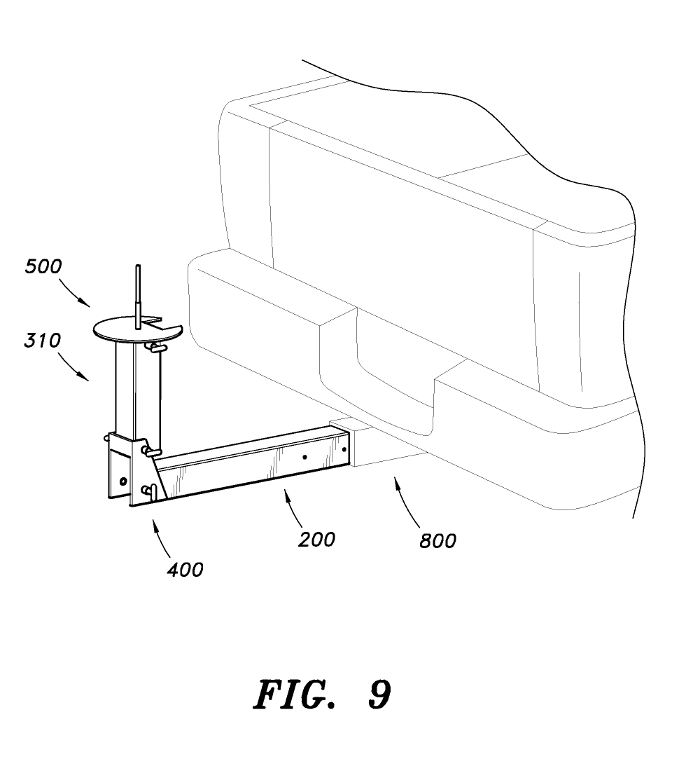

FIG. 10 is an environmental, perspective view of the tire support stand connected to a trailer hitch.

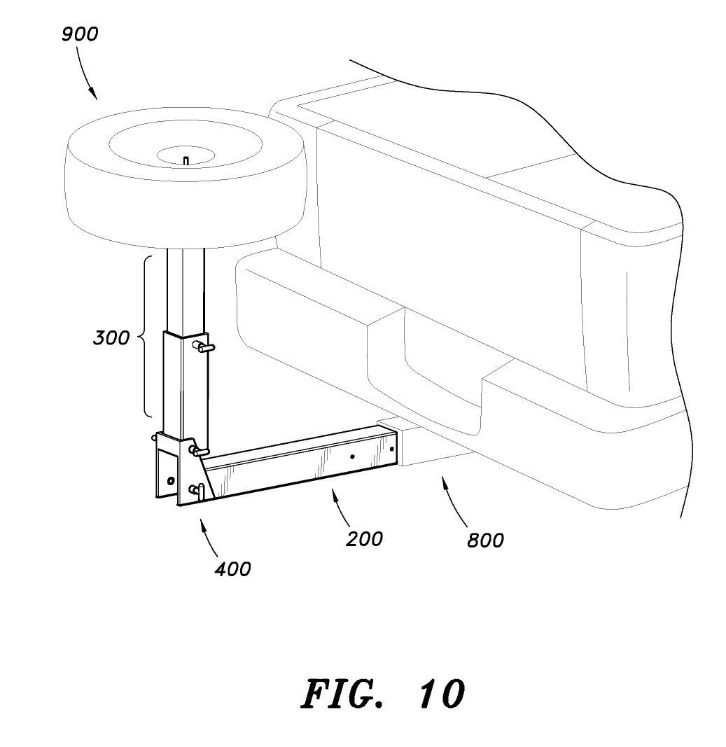

FIG. 11 is an environmental, perspective view of the tire support stand connected to a trailer hitch.

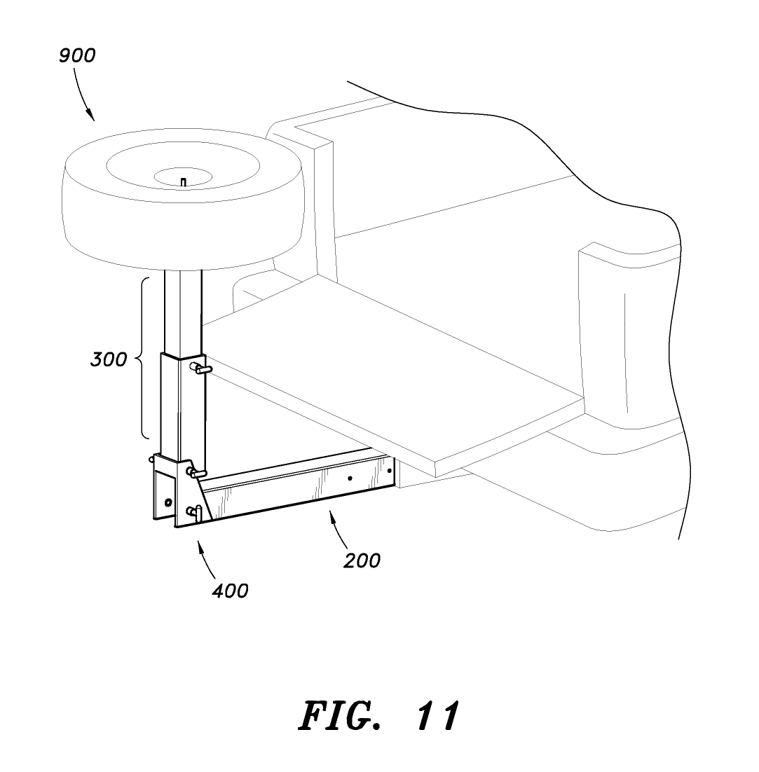

Similar reference characters denote corresponding features consistently throughout the attached drawings.

### DETAILED DESCRIPTION OF THE PREFERRED EMBODIMENTS

The present invention is directed to a tire changing station. More specifically, the invention is a portable motorcycle tire support stand. The tire support stand of the present invention is denoted generally by the numeric label “100”.

The description and Figures presented herein demonstrate that the present invention may be practiced or implemented in a variety of embodiments. The discussion of these embodiments amounts to a complete written description that enables those of ordinary skill in the art to make and use the invention. While several embodiments are expressly disclosed herein, it should be appreciated that the present invention is not limited to the specifically disclosed embodiments. Indeed, the structures, features, operations or functions of the described may be reorganized or reconfigured to create one or more structural or functional equivalent embodiments of the invention that are not specifically discussed herein, but nevertheless fall within the scope of the present invention.

Further, for purposes of description herein, while the terms “upper,” “lower,” “right,” “left,” “rear,” “front,” “vertical,” “horizontal,” and derivatives thereof are used herein to assist the reader, it should be understood that the invention may assume various orientations and step sequences, except where expressly specified to the contrary. U.S. patent numbers mentioned in this disclosure together with U.S. Pat. No. 6,244,010 are incorporated herein by reference in their entirety.

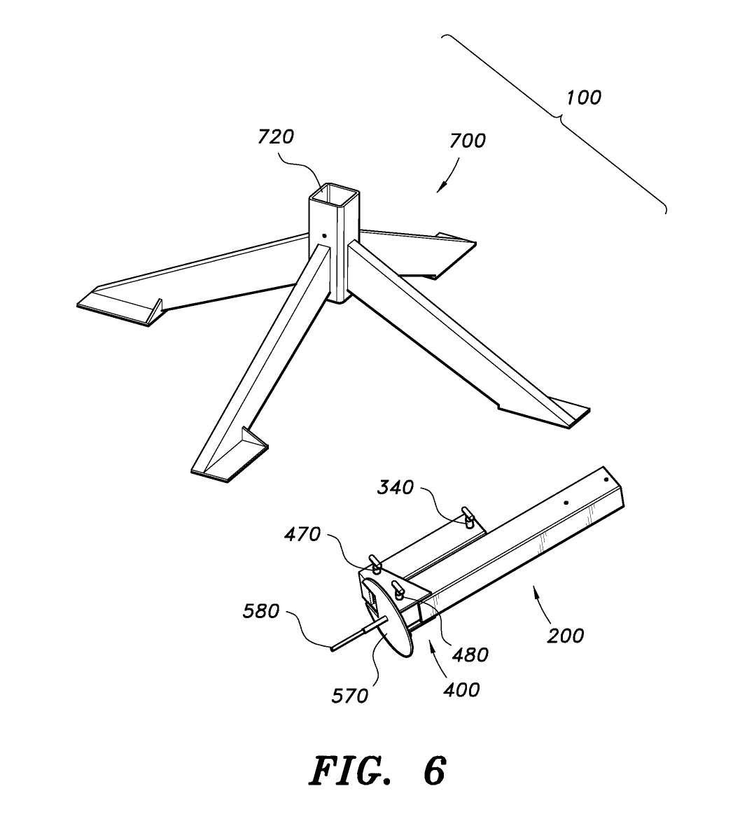

Referring to the Figures in general, the tire support stand 100 of the present invention comprises a support stand which can be any suitable support such as, not limited to, a tripod stand 700. The support stand is detachable; for example, the tripod stand 700 can be detached or separated as shown in FIG. 6.

The support stand 100 also includes a connecting arm 200. The connecting arm may be a hollow drawbar of rectangular cross section, having a front wall 210, rear wall 220, top wall 230 and bottom wall 240. The connecting arm has first and second opposite ends, 260 and 270 respectively, either of which is dimensioned to fit inside a trailer hitch receiver 800, or a slot 720 in tripod stand 700. The first opposite end 260 of the connecting arm is open, whereas the second opposite end 270 may be open or closed. Each opposite end of the connecting arm has two opposite side aligned through-holes 250, one on each opposite front and rear wall of the connecting arm. The through-holes 250 on the second opposite end 270 of the connecting arm can align with holes 810 in the trailer hitch receiver. A securing pin 600 can then be inserted through the aligned holes to secure the connecting arm 200 to the vehicle trailer hitch 800. Each securing pin 600 is preferably threaded and includes a handle for screwing the pin into a complementary threaded nut, receiver, or threaded bore. A threaded receiver, nut and/or washer can be coaxially coupled to the threaded pin to tighten and secure the connecting arm to the trailer hitch. When the connecting arm 200 is secured to the trailer hitch 800, the connecting arm is in a horizontal orientation, parallel to the ground.

The connecting arm 200 is attached to a securing bracket 400. The securing bracket 400 defines a sleeve having a floor 410, front wall 420 and rear wall 430, and a partial left wall 440. In a preferred embodiment, the connecting arm 200 is inside the securing bracket 400, attached to the floor of the bracket 410 through welding, fastening, bonding or some other appropriate means. The securing bracket 400 includes two aligned top opposite side through-bores 470, one on each front and rear wall of the securing bracket 400. Two bottom opposite side through-bores, 480 are similarly disposed, one on each front and rear wall of the securing bracket. The connecting arm 200 is preferably attached to the securing bracket 400 such that the through-holes 250 of the first end 260 of the connecting arm align with the bottom opposite side through-bores 480 of the securing bracket. When aligned in this manner, the through-holes of the connecting arm 250 and the corresponding bottom opposite side through-bores 480 of the securing bracket will accommodate a securing pin 600. The through bores of the present invention are preferably threaded and are adapted to coaxially engage with a threaded securing pin. In other words, a threaded pin can be threaded into the through-bore on the front wall of the securing bracket, pass through the aligned through holes of the connecting arm and thread into the opposite side through-bore on the rear wall of the securing bracket to secure and tighten the connecting arm to the securing bracket.

A telescopic arm 300 is pivotally attached to the inside of the securing bracket 400. The telescopic arm includes a sleeve member 310 that may take the form of a drawbar of rectangular cross section. The sleeve member defines a front wall 312, rear wall 314, top wall 316 and bottom wall 318. In addition, the sleeve member 310 has first and second opposite ends, 320 and 330 respectively, each opposite end having two opposite side aligned through-holes 336, one on each of the front and rear walls of the sleeve member. The first opposite end of the sleeve member 320 is inside the bracket, such that the first opposite end through-holes 336 of the sleeve member align with the top opposite side through-bores 470 of the securing bracket 400. A securing pin 600 can be inserted through the aligned opposite side through-bores 470 and through-holes 336, pivotally connecting the sleeve member 310 to the securing bracket. In a preferred embodiment, the securing pin is threaded to coaxially engage with the opposite side through-bores to secure and tighten the sleeve member 310 to the securing bracket 400.

In addition, the second opposite end of the sleeve member has a through-bore 340 on the front wall and an aligned through hole 346 on the opposite rear wall of the sleeve member dimensioned to receive a securing pin 600. The securing pin is used to secure the sleeve member 310 to an extendable arm 350, discussed in more detail below.

An extendable arm 350 extends in and out of sleeve member 310 and together they form the telescopic arm 300. The extendable arm 350 may take the form of a draw bar of rectangular cross section with a front wall 352, rear wall 354, top wall 356 and bottom wall 358. The extendable arm has first and second opposite ends, 360 and 370 respectively, and two opposite side aligned through-holes 380, one on each front and rear wall of the extendable arm. The second opposite end 370 of the extendable arm is open, whereas the first opposite end 360 may be open or closed. The through holes are located at strategically placed positions along the extendable arm 350, so that the through-holes 380 of the extendable arm selectively align with the threaded bore of the sleeve member 340. A securing pin 600 may be inserted to attach the extendable arm to the sleeve member at any position in which the through-holes of the extendable arm and the through-bore of the sleeve member are in alignment. In a preferred embodiment, the securing pin is threaded to coaxially engage with the through-bore which is also preferably threaded. A threaded receiver, through-bore, nut and/or washer on the other side of the rear wall of the sleeve member may be coaxially coupled to the threaded pin to secure and tighten the extendable arm to the sleeve member.

The telescopic arm 300 is pivotally connected to the top of the securing bracket 400. The telescopic arm pivots about an axis that passes through the center of the top opposite side through-bores 470 of the securing bracket and rotates in a plane perpendicular to the pivot axis. Furthermore, the telescopic arm 300 is able to pivot from a position adjacent to the connecting arm 200 to a position roughly perpendicular to the connecting arm, also known as the “open” position. The partial left wall of the securing bracket 440 prevents the telescopic arm from rotating more than about ninety degrees relative to the connecting arm.

A spindle platform 500 to support a tire is optionally mounted on either the second opposite end 370 of the extendable arm of the telescopic arm, or the first opposite end 260 of the connecting arm 200. The spindle platform includes a rectangular base 510, a circular platform with rectangular notch 570, and a central rod 580 extending from the center of the circular platform. The rectangular base 510 has a front wall 520, rear wall 530, left wall 540 and right wall 550. The base 510 is dimensioned to fit into second opposite end of the extendable arm 370 or the first opposite end 260 of the connecting arm 200. The base 510 preferably includes two oppositely aligned through-holes 560, one on each opposite wall of the base. The opposite side through-holes 560 of the base align with the through-holes 380 of the second opposite end 370 of the extendable arm 350 when the spindle platform 500 is mounted therein. Alternatively, the opposite side through-holes 560 of the spindle platform base align with the through-holes 250 of the first opposite end 260 of the connecting arm and the opposite side bottom through-bores 480 of the securing bracket when the spindle platform is mounted therein. A securing pin 600 is inserted through the aligned through-holes and/or through-bores to secure the spindle platform to either the extendable arm 350 or the connecting arm 200. In a preferred embodiment, a threaded receiver, through-bore, nut and/or washer coaxially couples to the threaded pin to secure and tighten the spindle platform base to either the extendable arm or the connecting arm.

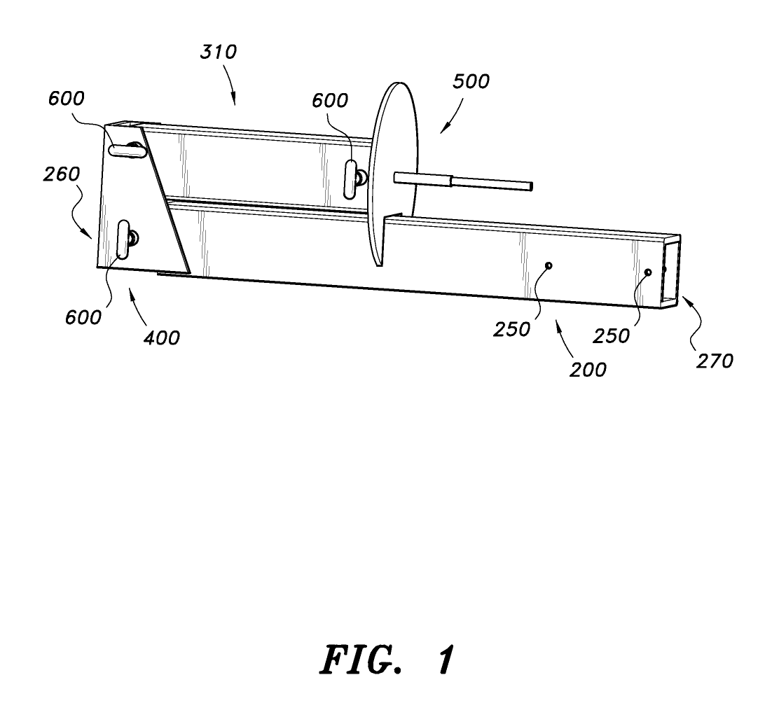

In a preferred embodiment, the rectangular notch 590 in the circular platform 570 of the spindle platform 500 is dimensioned to accommodate part of the connecting arm as shown in FIG. 1. In other words, when the tire support stand is folded, the rectangular notch 590 in the circular platform 570 enables the telescopic arm 300 to lie parallel to the connecting arm by providing a groove for the connecting arm to slide into.

The connecting arm of the tire support stand may be mounted in either a vehicle trailer hitch 800 or the tripod stand 700. The tripod stand includes a slot 720 at its apex dimensioned to receive the second opposite end of the connecting arm 270. If mounted in the tripod stand 700 the tire support stand 100 is in a vertical orientation, perpendicular to the ground. The telescopic arm 300 is in a folded position, adjacent to the connecting arm 200, while the spindle platform 500 is mounted at the top of the connecting arm so that a tire 900 can be placed over the central rod 580 of the spindle platform for repair or changing. More specifically, the base of the spindle platform 510 is inserted into the opening of the first opposite end 260 of the connecting member.

If mounted in a trailer hitch receiver 800, the tire support stand 100 is folded out to form an L-shape. More specifically, the connecting arm 200 is in a horizontal orientation, parallel to the ground, and the telescopic arm 300 is rotated up to a position perpendicular to the connecting arm. The spindle platform 500 is mounted at the top of the now vertical telescopic arm. More specifically, the base 510 of the spindle platform is inserted into the second opposite end 370 of the extendable arm of the telescopic arm. A tire 900 can then be placed over the central rod 580 of the spindle platform 500.

In actual use, the connecting arm 200 of the tire support stand can be inserted into either a trailer hitch receiver or a tripod stand. If the connecting arm 200 is mounted to a hitch receiver 800, the telescopic arm 300 is folded out, i.e. rotated up to a vertical position, perpendicular to the connecting arm. The spindle platform 500 is then mounted in the top opening of the telescopic arm, or more specifically the opening in the second opposite end 370 of the extendable arm. A tire can then be placed over the central rod 580 of the spindle platform for repair or changing. If the connecting arm 200 is mounted to the tripod stand 700, the telescopic arm 300 is folded to a position adjacent to the connecting arm 200. In this position, the extendable arm 350 can be retracted into the sleeve member 310. The spindle platform 500 is mounted at the top open end of the connecting arm, i.e. the first opposite end 260 of the connecting arm. A tire can then similarly be placed over the spindle portion of the spindle platform for repair or changing.

It is to be understood that the present invention is not limited to the embodiments described above, but encompasses any and all embodiments within the scope of the following claims.

What is claimed:

1. A tire support stand, comprising:
a) a connecting arm;
b) a telescopic arm, the telescopic arm comprising:
(1) a sleeve member; and
(2) an extendable arm, wherein the extendable arm extends in and out of the sleeve member;
c) a securing bracket;
d) a spindle platform, the spindle platform comprising:
(1) a base;
(2) a platform; and
(3) a central rod extending from the platform.
e) a plurality of securing pins; and
f) a tripod.

2. The tire support stand according to claim 1, wherein the securing bracket defines a sleeve having a floor, and front and rear walls,

3. The tire support stand according to claim 2, wherein the securing bracket includes two top opposite side through-bores, one on each opposite wall of the securing bracket, and two bottom opposite side through-bores, one on each opposite wall of the securing bracket, wherein the top and bottom through-bores are aligned and dimensioned to receive a securing pin.

4. The tire support stand according to claim 3, wherein the connecting arm has front, rear, top and bottom walls, wherein the connecting arm has first and second opposite ends, wherein the first opposite end is open, wherein each opposite end has two through-holes on opposite front and rear walls of the connecting arm, wherein the first opposite end is inside the bracket sleeve, attached to the floor of the bracket, such that the first opposite end though-holes align with the bottom opposite side through-bores of the securing bracket, wherein the second opposite end of the connecting arm is dimensioned to fit in a vehicle trailer hitch receiver.

5. The tire support stand according to claim 4, wherein the sleeve member comprises front, rear, top and bottom walls, wherein the sleeve member has first and second opposite ends, wherein each opposite end has two opposite aligned through-holes, one on each opposite front and rear wall of the sleeve member, wherein the first opposite end of the sleeve member is inside the bracket and attached to the top of the bracket such that the first opposite end through-holes align with the top opposite side threaded bores of the securing bracket,

6. The tire support stand according to claim 5, wherein a securing pin inserted through the aligned opposite side bores and through-holes pivotally connects the sleeve member to the securing bracket, wherein the second opposite end of the sleeve member has a through-bore dimensioned to receive a securing pin;

7. The tire support stand according to claim 6, wherein the extendable arm has front, rear, top and bottom walls, wherein the extendable arm is dimensioned to fit inside the sleeve member of the telescopic arm.

8. The tire support stand according to claim 7, wherein the extendable arm has first and second opposite ends, wherein the second opposite end is open, wherein the extendable arm has opposite side aligned through-holes on the front and rear walls of the extendable arm at strategically placed positions along the extendable arm, wherein the through-holes of the extendable arm selectively align with the through-bore of the sleeve member, wherein a securing pin may be inserted to attach the extendable arm to the sleeve member at any position in which the through-holes of the extendable arm and the threaded bore of the sleeve member are in alignment.

9. The tire support stand according to claim 8, wherein the base of the spindle platform is dimensioned to fit into an open end of the extendable arm or an open end of the connecting arm, wherein the base includes opposite side through-holes, wherein the opposite side through-holes of the base align with the through-holes of either the extendable arm, or the opposite side bottom through-bores of the securing bracket when the base is inserted therein, wherein a securing pin is inserted through the aligned through-holes or through-bores to secure the spindle platform to either the extendable arm or the connecting arm.

10. The tire support stand according to claim 9, wherein the tripod has a slot at its apex dimensioned to receive the second opposite end of the connecting arm.

11. The tire support stand according to claim 10, whereby in actual use the connecting arm of the tire support stand can be inserted into either a trailer hitch receiver or the tripod stand, wherein if the tire support stand is mounted to a hitch receiver, the telescopic arm is rotated up from a position adjacent to the connecting arm to a vertical position, perpendicular to the connecting arm, so that the spindle platform can be mounted in the second opposite end of the extendable arm and a tire can be placed over the spindle portion of the spindle platform for repair or changing, wherein if the tire support is mounted to the tripod stand, the telescopic arm is folded to a position adjacent to the connecting arm, wherein the extendable arm may be retracted into the sleeve member, wherein the spindle platform is mounted to the first opposite end of the connecting arm, so that a tire can be placed over the spindle portion of the spindle platform for repair or changing.
